(19) United States
(12) Patent Application Publication
(10) Pub. No.: US 2020/0364758 A1
(43) Pub. Date: Nov. 19, 2020

(54) Closed-Loop Control Mechanism to Optimize AI-Based Customer Support Performance for Customer Satisfaction, Customer Effort, or any Other Customer Satisfaction Metric

(71) Applicant: Dell Products L.P., Round Rock, TX (US)

(72) Inventors: Patrick Dwane, Mitchelstown (IE); Henrique C. Wisnieski, Eldorado do Sul (BR); Vishnu Gawas, Hyderabad (IN)

(73) Assignee: Dell Products L.P., Round Rock, TX (US)

(21) Appl. No.: 16/413,944

(22) Filed: May 16, 2019

(51) Int. Cl. G06Q 30/02; G06Q 30/00; H04M 3/51; H04L 12/58; G06Q 10/06

(52) U.S. Cl. CPC G06Q 30/0281; G06Q 30/016; G06F 17/2785; H04L 51/02; G06Q 10/06393; H04M 3/5175

(57) ABSTRACT

A system, method, and computer-readable medium are disclosed for performing a customer support performance optimization operation which includes optimizing performance of an artificial intelligence (AI) enabled customer support system. The customer support performance optimization operation includes receiving a customer issue associated with a particular customer; classifying the customer issue; determining a solution to the customer issue; identifying an optimum support issue resolution option; implementing the optimum support issue resolution option; and, measuring customer satisfaction regarding the support issue resolution.

### BACKGROUND OF THE INVENTION

### Field of the Invention

The present invention relates to information handling systems. More specifically, embodiments of the invention relate to optimizing the performance of an artificial intelligence (AI) enabled customer support system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

A system, method, and computer-readable medium are disclosed for performing a customer support performance optimization operation which includes optimizing performance of an artificial intelligence (AI) enabled customer support system.

More specifically, in one embodiment the invention relates to a computer-implementable method for providing customer support, comprising: receiving a customer issue associated with a particular customer; classifying the customer issue; determining a solution to the customer issue; identifying an optimum support issue resolution option; implementing the optimum support issue resolution option; and, measuring customer satisfaction regarding the support issue resolution.

In another embodiment the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: receiving a customer issue associated with a particular customer; classifying the customer issue; determining a solution to the customer issue; identifying an optimum support issue resolution option; implementing the optimum support issue resolution option; and, measuring customer satisfaction regarding the support issue resolution.

In another embodiment the invention relates to a computer-readable storage medium embodying computer program code, the computer program code comprising computer executable instructions configured for: receiving a customer issue associated with a particular customer; classifying the customer issue; determining a solution to the customer issue; identifying an optimum support issue resolution option; implementing the optimum support issue resolution option; and, measuring customer satisfaction regarding the support issue resolution.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a block diagram of an artificial intelligence (AI) enabled customer support environment.

FIG. 3 shows a functional process diagram depicting the operation of a closed-loop controller to optimize the performance of an AI-enabled customer support system.

FIG. 4 shows a table of customer satisfaction (CSat) prediction data.

FIG. 5 shows a histogram of customer effort ratings.

FIG. 6 shows a graph depicting the distribution of CSat data.

FIG. 7 shows a graph depicting CSat score distributions associated with attainment of CSat proficiency.

FIG. 8 shows an example screen presentation of an AI-enabled customer support system user interface (UI).

### DETAILED DESCRIPTION

A system, method, and computer-readable medium are disclosed for optimizing the performance of an artificial intelligence (AI) enabled customer support system. Certain aspects of the invention reflect an appreciation that a customer's request for assistance to resolve an issue may take many forms, such as appointments, phone conversations, exchanges of email or instant messages, initiating trouble tickets, and so forth. The lifecycle of such requests is typically managed in the form of a case, which has an associated case manager, who acts as the customer's point of contact. Certain aspects of the invention reflect an appreciation that it is common for a customer to appraise the management, and eventual resolution, of such cases in terms of customer satisfaction (CSat) or customer effort score (CES) ratings, described in greater detail herein.

Certain aspects of the invention likewise reflect an appreciation that the use of artificial intelligence (AI) enabled customer support systems has become common in recent years and are predicted to become more prevalent over time. Likewise, various aspects of the invention reflect an appreciation that certain AI-enabled customer support systems are often able to generate accurate, fully automated, case resolutions for customers, with little or no need for case manager interactions. However, certain aspects of the invention likewise reflect an appreciation that the current AI-enable customer support systems often fail to identify customer dissatisfaction with various customer support issues. Examples of such issues include insistence upon adhering to certain sequence of automated process steps, requiring a subject matter expertise to operationalize, and the inability to systematically quantify, in real-time, the suitability and resulting impact of end-to-end resolution process characteristics. Accordingly, certain aspects of the invention reflect an appreciation that it may be advantageous to have an AI-enabled customer support system provide a suggested solution for certain customer support issues to a case manager for validation prior to the solution being provided to a customer.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

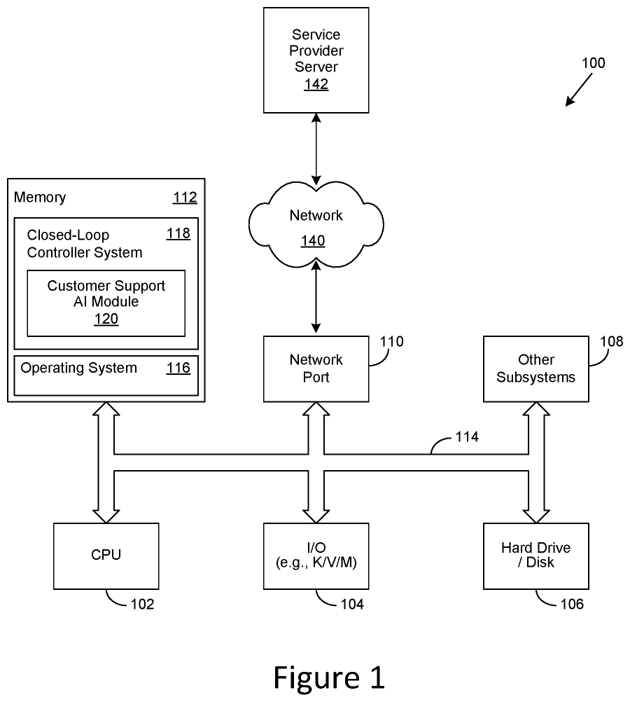

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, a touchpad or touchscreen, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a closed-loop controller system 118. In certain embodiments, the closed-loop controller system 118 may include a customer support artificial intelligence (AI) module 120. In one embodiment, the information handling system 100 is able to download the closed-loop controller system 118 from the service provider server 142. In another embodiment, the closed-loop controller system 118 is provided as a service from the service provider server 142.

The closed-loop controller system 118 performs an artificial intelligence (AI) enabled customer support system optimization operation. The AI-enabled customer support system optimization operation improves processor efficiency, and thus the efficiency of the information handling system 100, facilitating the AI-enabled customer support system optimization operation. In certain embodiments, the AI-enabled customer support system optimization operation can be performed during operation of an information handling system 100. As will be appreciated, once the information handling system 100 is configured to perform the AI-enabled customer support system optimization operation, the information handling system 100 becomes a specialized computing device specifically configured to perform the AI-enabled customer support system optimization operation and is not a general purpose computing device. Moreover, the implementation of the AI-enabled customer support system optimization operation on the information handling system 100 improves the functionality of the information handling system 100 and provides a useful and concrete result of optimizing the performance of an AI-enabled customer support system.

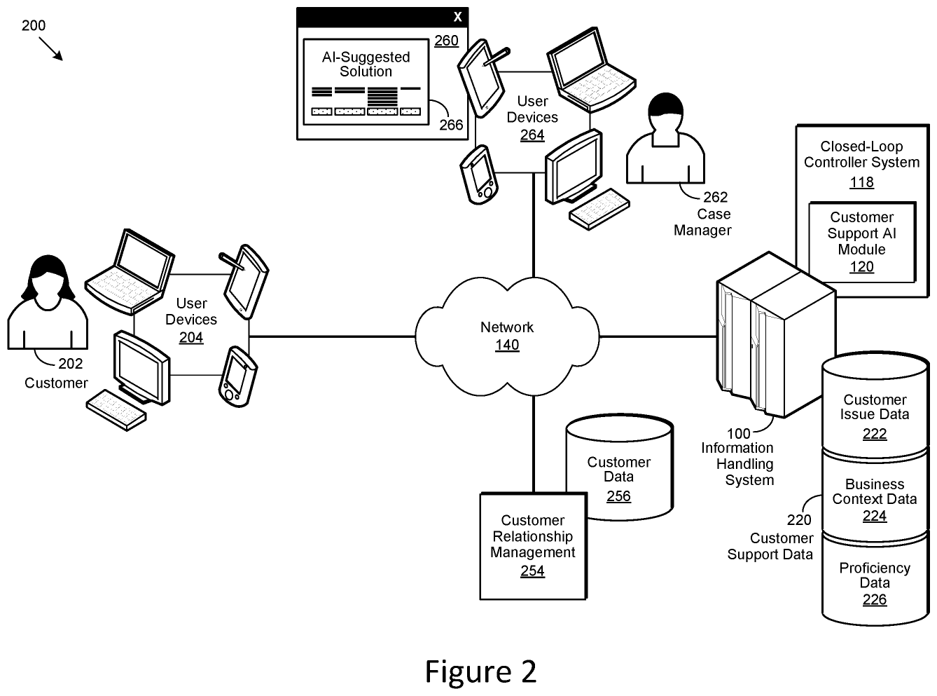

FIG. 2 is a block diagram of an artificial intelligence (AI) enabled customer support environment 200 implemented in accordance with an embodiment of the invention. In certain embodiments, the artificial intelligence (AI) enabled customer support environment 200 may include a closed-loop controller system 118. In certain embodiments, the artificial intelligence (AI) enabled customer support environment 200 may include a repository of customer support data 220. In certain embodiments, the repository of customer support data 220 may be local to the system executing the closed-loop controller system 118 or may be executed remotely. In certain embodiments, the repository of customer support data 220 may include various information associated with customer issue data 222, business context data 224, and customer support proficiency data 226, or a combination thereof.

In certain embodiments, the closed-loop controller system 118 may include a customer support AI module 120. In certain embodiments, the closed-loop controller system 118 may be implemented to optimize the performance of the AI-enabled customer support environment. In certain embodiments, the customer support AI module 120 may be implemented by the closed-loop controller system 118 to automatically provide an AI-suggested solution for a customer support issue to a customer 202. In certain embodiments, the customer support AI module may be implemented by the closed-loop controller system 118 to deliver an AI-suggested solution 266 to a case manager 262 for validation, as described in greater detail herein.

In certain embodiments, a customer 202 or case manager 262 may respectively use a user device 204, 264 to interact with the closed-loop controller system 118. As used herein, a user device 204, 264 refers to an information handling system such as a personal computer, a laptop computer, a tablet computer, a personal digital assistant (PDA), a smart phone, a mobile telephone, or other device that is capable of communicating and processing data. In certain embodiments, a user device 264 associated with a case manager 262 may be configured to present a closed-loop controller system user interface (UI) 260. In certain embodiments, the closed-loop controller system UI 260 may be implemented to present a graphical representation 266 of an AI-suggested solution to a customer support issue, which is automatically generated in response to interaction with the closed-loop controller system 118.

In certain embodiments, the user device 264 is used to exchange information between the case manager 262, the closed-loop controller system 118, and a customer relationship management (CRM) system 254 through the use of a network 140. In certain embodiments, the CRM system 254 may include a repository of customer data 256. In certain embodiments, the network 140 may be a public network, such as a public internet protocol (IP) network, a physical private network, a wireless network, a virtual private network (VPN), or any combination thereof. Skilled practitioners of the art will recognize that many such embodiments are possible and the foregoing is not intended to limit the spirit, scope or intent of the invention.

In various embodiments, the closed-loop controller system UI 240 may be presented via a website. In certain embodiments, the website may be provided by one or more of the closed-loop controller system 118 and the CRM system 254. For the purposes of this disclosure a website may be defined as a collection of related web pages which are identified with a common domain name and is published on at least one web server. A website may be accessible via a public IP network or a private local network.

A web page is a document which is accessible via a browser which displays the web page via a display device of an information handling system. In various embodiments, the web page also includes the file which causes the document to be presented via the browser. In various embodiments, the web page may comprise a static web page, which is delivered exactly as stored and a dynamic web page, which is generated by a web application that is driven by software that enhances the web page via user input to a web server. In certain embodiments, the closed-loop controller system 118 may be implemented to interact with the CRM system 254, which in turn may be executing on a separate information handling system 100.

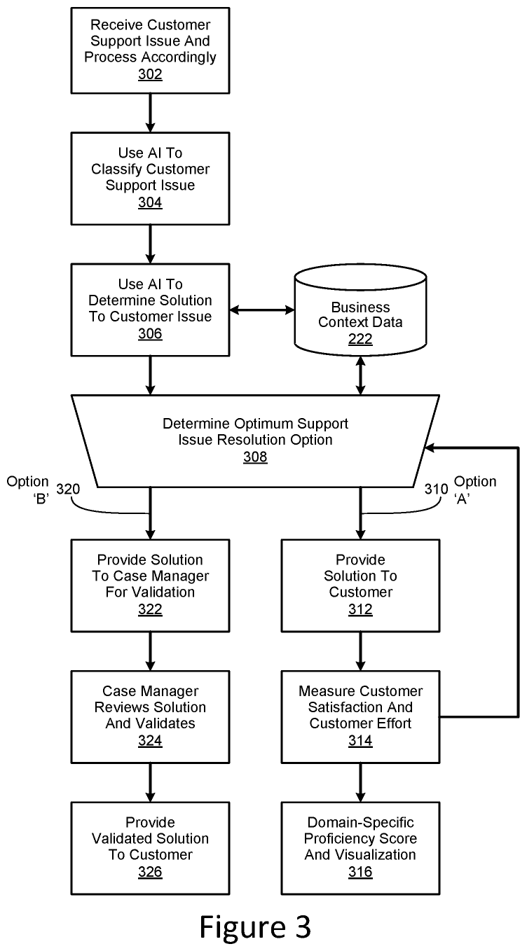

FIG. 3 shows a functional process diagram depicting the operation of a closed-loop controller implemented in accordance with an embodiment of the invention to optimize the performance of an artificial intelligence (AI) enabled customer support system. In this embodiment, a customer issue is received in step 302, which initiates a new case. As an example, a customer may submit an email inquiry requesting a status update for a particular order. In this example, the contents of the email may be processed by a natural language processing (NLP) system to generate data suitable for ingestion into an AI-enabled customer support system. The resulting data is then associated with the customer's case.

As another example, a customer may place a telephone call and interact with an interactive voice response (IVR) system and leave an associated voice message. As before, the voice message may be processed by an NLP system to generate associated customer issue data, which is then combined with the results of the interaction with the IVR system. The combined data is then associated with the customer's case. As yet another example, a customer may have a verbal or textual exchange with a chatbot, familiar to those of skill in the art, which captures details associated with the customer's support issue, which in turn is associated with the customer's case. Skilled practitioners of the art will recognize that many such examples are possible. Accordingly, the foregoing is not intended to limit the spirit, scope or intent of the invention.

The data associated with the customer's case is then used in step 304 by an AI-enabled customer support system to perform customer support issue classification operations. In certain embodiments, the customer support issue classification operations may be performed by the customer support AI module 120 shown in FIGS. 1 and 2. In certain embodiments, the customer support issue classification operations may result in the generation of a customer sentiment score, an issue complexity rating, and a classification confidence score, or a combination thereof. For example, the customer support issue classification operations may result in a customer sentiment score of ‘0.5’, an issue complexity rating of “low,” and a classification confidence rating of ‘0.8’.

As used herein, customer sentiment broadly refers to a customer's emotional attitude towards a particular issue, such as how well a product performs, the value realized by use of a provided service, or how associated problems are resolved. In general, customer sentiment is expressed in positive, neutral or negative terms. In certain embodiments customer sentiment may characterized by a numeric score. As an example, the customer sentiment score may range from ‘−1’ to ‘+1’, with ‘−1’ being the most negative sentiment and ‘+1’ being the most positive sentiment. As another example, the customer sentiment score may range from ‘0’ to ‘+1’, with ‘0’ being the most negative sentiment and ‘+1’ being the most positive sentiment. Accordingly, customer sentiment scores of ‘0.3’, ‘0.5’ and ‘0.8’ may respectively correlate to generally negative, neutral, and generally positive customer sentiment.

Likewise, as used herein, an issue complexity rating broadly refers to an assessment of the relative complexity of a customer support issue. In certain embodiments, the issue complexity rating may be based upon quantitative data, qualitative criteria, operational parameters, or a combination thereof. In certain embodiments, the customer support issue complexity rating may be based upon the issue's lexical diversity. As used herein lexical diversity broadly refers to a measure of the proportion of lexical items (i.e. nouns, verbs, adjectives and some adverbs) in a particular body of text, such as a customer request, described in greater detail herein. In certain embodiments, the customer support issue complexity rating may be based upon the character count with a particular body of text, such as a customer request. Those of skill in the art will recognize that many such embodiments are possible. Accordingly, the foregoing is not intended to limit the spirit, scope or intent of the invention.

As likewise used herein, classification confidence rating broadly refers to a measurement of confidence that a customer's support issue type has been accurately classified. In certain embodiments, a customer support AI module 120, such as shown in FIGS. 1 and 2, may be implemented to process a customer request and assign it a customer support issue type and associated classification confidence rating. As used herein, a customer request broadly refers to an action that a customer, in their own words, wishes to have performed, such as, “I really need to get an updated Order Status.” As an example, a customer request containing the preceding text may be assigned an issue type of “Order Status Query” with a classification confidence rating of ‘0.8’. In certain embodiments, a classification confidence rating may be based upon quantitative data, qualitative criteria, operational parameters, or a combination thereof. In certain embodiments, the classification confidence rating may be expressed as a quantitative or qualitative value. In these embodiments, the method by which a customer sentiment score, an issue complexity rating, or a classification confidence score is expressed is a matter of design choice.

The AI-enabled customer support system is then used in step 306 to determine a solution for the customer's support issue. In certain embodiments, contextual customer information relevant to the customer's support issue may be retrieved from a corresponding repository of business context data 222. In certain embodiments, the contextual customer information may include historical order performance, number of customer contacts, and so forth. In certain embodiments, the contextual customer information may be used to determine a solution for the customer's support issue.

In certain embodiments, the contextual customer information may include an order experience score, which is a contextual data point that serves as an assessment of the customer's experience when placing an order for a product or service. In certain embodiments, the customer's experience may be associated with various user interactions, such as mouse clicks, movements and hovers, page scrolls, device rotations, and other user behavior when viewing certain content within a user interface (UI). In certain embodiments, the user interactions may be associated with the underlying context of the content the user may be viewing. As an example, an order experience score could range from ‘0’ to ‘100’, where ‘0’ is the lowest score and ‘100’ is the highest.

In certain embodiments, the retrieved business context data may be used in step 306 by a customer support AI module 120, shown in FIGS. 1 and 2, to determine a solution for the customer's support issue. As an example, a solution for determining the status of an order might be based upon the estimated delivery date of the order, along with other information, such as certain carrier tracking information. To continue the example, inability to retrieve a carrier's waybill tracking number may result in assessing the completeness of the solution to be 80%.

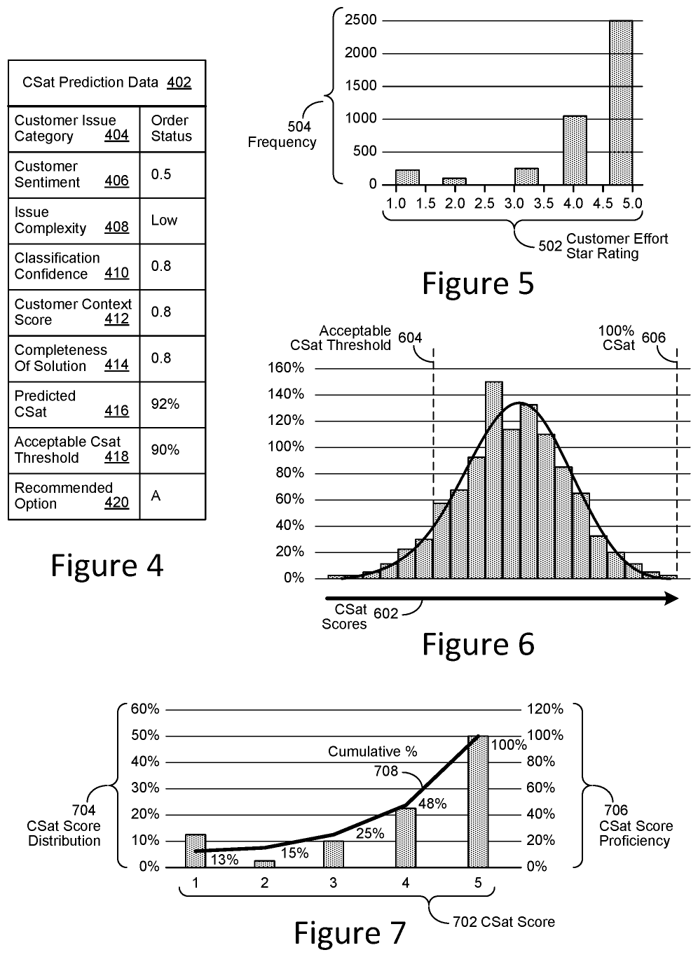

The solution to the customer's support issue determined in step 306 is then processed with associated business context data in step 308 to determine the optimum customer support issue resolution option. In certain embodiments, a closed-loop controller system 118, shown in FIGS. 1 and 2, may be implemented to determine the optimum customer support issue resolution option. In various embodiments, certain customer satisfaction (CSat) prediction data 402 depicted in the table shown in FIG. 4 may be used by the closed-loop controller system 118 to determine the optimum customer support issue resolution option. As an example, customer support issue resolution option ‘A’ 310 or ‘B’ 320 may be chosen according to a comparison of a predicted CSat score (e.g., 92%) for the customer's support issue to an acceptable CSat threshold (e.g., 90%).

If customer support issue resolution option ‘A’ 310 is chosen, then the solution to the customer's support issue is provided to the customer in step 312. Thereafter, customer satisfaction (CSat) score and customer effort score (CES) metrics, described in greater detail herein, are collected in step 314 and provided as feedback to the closed-loop controller system 118 used in step 308. Thereafter, domain-specific proficiency scores are generated and visualized in step 316. In certain embodiments, a domain-specific proficiency score may be generated to indicate the performance of the closed-loop controller system 118 relative to a particular domain, or aspect, of customer support issue resolution.

In certain embodiments, a domain-specific proficiency score may be implemented to indicate the proficiency of a certain enterprise-to-enterprise (E2E) operations, processes or functions. As used herein, E2E broadly refers to the exchange of information or transactions between websites that serve as brokers of goods, services, or information between organizations. Accordingly, E2E may be considered a form of business-to-business (B2) interactions.

In various embodiments, an E2E domain-specific proficiency score may be implemented to serve as a foundation for performing certain business process reengineering (BPR) operations, processes, or functions familiar to skilled practitioners of the art. Various embodiments of the invention reflect an appreciation that the results of such BPR operations, processes, or functions may assist in optimizing certain operational activities (OAs), which in turn may encourage interoperability between organization units and enable cross-functional processes. However, if customer support issue resolution option ‘B’ 320 is chosen, then the solution to the customer's support issue is provided to the assigned case manager in step 322. The case manager then reviews the solution for validation in step 324, and if it is determined to be valid, it is provided to the customer 326.

FIG. 4 shows a table of customer satisfaction (CSat) prediction data implemented in accordance with an embodiment of the invention. Certain embodiments of the invention reflect an appreciation that customer satisfaction (CSat) and customer effort score (CES) data associated with resolution of a particular customer support issue is an example of an imbalanced dataset. As used herein, an imbalanced dataset broadly refers to a set of data where the classes of data are not represented equally. For example, a dataset may contain 100 instances of data, 80 of which are associated with one class and 20 are associated with another. In this example, the imbalanced data set has an imbalance ratio of 4:1. Various embodiments of the invention reflect an appreciation that the use of an imbalanced dataset may result in certain implications when used in supervised machine learning approaches familiar to those of skill in the art.

Various embodiments of the invention likewise reflect an appreciation that certain implementations of the closed-loop controller system 118 shown in FIGS. 1 and 2 may provide an accurate, scalable solution for predicting incidences of high customer effort and low customer satisfaction. Certain embodiments of the invention reflect an appreciation that the imbalanced nature of a dataset may result in excellent accuracy (e.g., 90%) that merely reflects underlying class distribution. Certain embodiments of the invention likewise reflect an appreciation that such accuracy may not be an ideal metric to use when working with an imbalanced dataset.

Accordingly, in certain embodiments, the invention may be implemented to use an F1 score, also referred to as an F-score, and a Kappa coefficient, likewise referred to as Cohen's kappa, as evaluation metrics. Skilled practitioners of the art will be familiar with an F1 score, which is a weighted average of precision and recall. Those of skill in the art will likewise be familiar with Kappa, which refers to classification accuracy normalized by the imbalance of the classes in the data.

Referring now to FIG. 4, certain CSat prediction data 402 may be used, as described in the text associated with FIG. 3, to determine an optimum customer support issue resolution option ‘A’ 310 or ‘B’ 320. In certain embodiments, the CSat prediction data 402 may include a customer support issue category 404, a customer sentiment score 406, an issue complexity rating 408, a classification confidence rating 410, and a customer context score 412, all of which are described in greater detail herein. In certain embodiments, the CSat prediction data 402 may include a completeness of solution score 414, which is a measure of how completely a customer support issue was resolved. To further continue the prior example of an Order Status Query, the estimated delivery date of the order, in addition to other information, such as carrier tracking information may be processed. In this example, inability to retrieve the carrier's waybill tracking number may result in the completeness solution score being 80%.

In certain embodiments, the the CSat prediction data 402 may include an acceptable customer satisfaction (CSat) threshold value 418. In these embodiments, the method by which the acceptable CSat threshold value 418 is selected, and the value itself, is a matter of design choice. In certain embodiments, a closed-loop controller may be implemented, as described in the text associated with FIG. 3, to use the acceptable CSat threshold value 418 to determine whether to select customer support issue resolution option 420 ‘A’ 310 or ‘B’ 320. As an example, an acceptable CSat threshold value 418 may be selected to be between 75% and 95% to ensure the customer is satisfied with the resolution of an associated customer support issue.

FIG. 5 shows a histogram of customer effort ratings implemented in accordance with an embodiment of the invention. In certain embodiments, a closed loop control system may be implemented with a customer support artificial intelligence (AI) module to validate imbalance associated with customer effort score (CES) data, described in greater detail herein, to predict instances of high customer effort when resolving a support issue. In certain embodiments, the CES data may StellaRating, which is a CES based upon a one to five star rating 502 system, with five stars being the highest rating. In certain embodiments, the StellaRating associated with the resolution of a particular customer service issue may be generated by a customer. In certain embodiments, the CES data may include the frequency 504 with which each StellaRating of one to five stars has been selected by various customers.

FIG. 6 shows a graph depicting the distribution of customer satisfaction (CSat) data implemented in accordance with an embodiment of the invention. In certain embodiments, as described in greater detail herein, an acceptable CSat threshold 604 is used to determine an optimum customer support issue resolution option. For example, as shown in FIG. 6, a CSat threshold 604 of 58% may be selected, out of a CSat maximum score 606 of 100%. In certain embodiments, the CSat threshold 604 may be selected according to a statistical distribution of CSat scores 602 from lowest to highest.

FIG. 7 shows a graph depicting customer satisfaction (CSat) score distributions associated with attainment of CSat proficiency in accordance with an embodiment of the invention. In various embodiments, CSat score proficiency score may be determined based upon the percentage of pass/fail criteria corresponding to certain CSat responses when a fully-automated customer support issue resolution option, such as option ‘A’ described in the text associated with FIG. 3, is selected. In certain embodiments, a fully-automated or semi-automated customer support issue resolution option may be selected by comparing a predicted CSat score for a fully-automated customer support issue resolution option to a particular threshold CSat score. In certain embodiments, CSat score proficiency 706 may be visualized by comparing individual CSat scores 702, such as ‘1’, ‘2’, ‘3’, ‘4’, and ‘5’, to their corresponding CSat score distribution 704. In certain embodiments, the visualization may include a cumulative percentage 708 of the CSat score distribution 704 across their corresponding CSat scores 702.

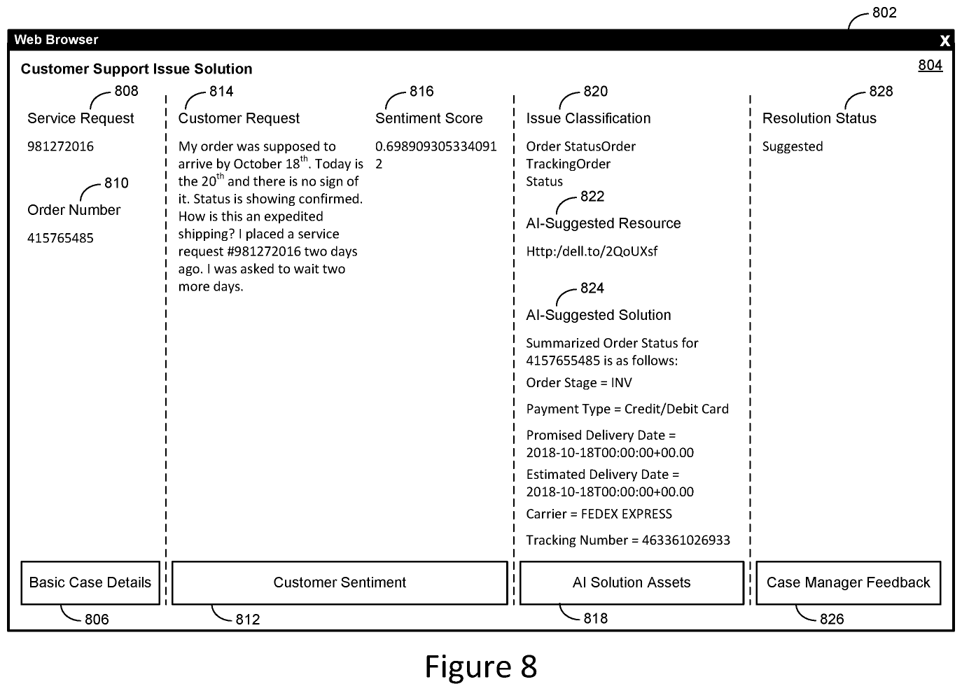

FIG. 8 shows an example screen presentation of an artificial intelligence (AI) enabled customer support system user interface (UI) implemented in accordance with an embodiment of the invention. In certain embodiments, a proposed solution to a particular customer's support issue may be provided to a case manager for validation prior to being provided to the customer. In certain embodiments, the proposed solution may be displayed within a customer support issue solution window 804 of the UI 802 for review by the case manager. In certain embodiments, the proposed solution may include information corresponding to basic case details 806, customer sentiment 812, artificial intelligence (AI) solution assets 818, and case manager feedback 826.

In certain embodiments, information associated with basic case details 806 may include an internal reference, such as a numerical identifier, to a particular customer support issue. In certain embodiments, the internal reference may be implemented as a service request 808 identifier associated with a particular customer support case. In certain embodiments, the basic case details may include an internal reference, such as a numerical identifier, to an order 810 for a particular product or service associated with a customer.

In certain embodiments, information associated with customer sentiment 812 may include a customer request 814 and a sentiment score 816, both of which are described in greater detail herein. In various embodiments, information associated with AI solution assets may include a customer support issue classification type 820, likewise described in greater detail herein, an AI-suggested resource 822, such as a hyperlink to certain product information, and an AI-suggested solution 824 to the customer's support issue. In certain embodiments, the information associated with case manager feedback 826 may include the resolution status 828 of the customer support issue.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for providing customer support, comprising:
receiving a customer issue associated with a particular customer;
classifying the customer issue;
determining a solution to the customer issue;
identifying an optimum support issue resolution option;
implementing the optimum support issue resolution option; and,
measuring customer satisfaction regarding the support issue resolution.

2. The method of claim 1, wherein:
the measuring customer satisfaction comprises identifying customer dissatisfaction associated with customer issues of the particular customer.

3. The method of claim 2, wherein:
the optimum support issue resolution option comprises assigning a case manager to the customer issue and providing an automated response to the customer issue to resolve the customer issue.

4. The method of claim 3, wherein:
the classifying comprises generating a customer sentiment score, an issue complexity rating and a classification confidence rating; and,
the case manager is assigned to the customer support issue when the customer sentiment score regarding the support issue resolution is lower than a predetermined level.

5. The method of claim 1, further comprising:
using the customer satisfaction regarding the support issue resolution when identifying a new optimum support issue resolution option for the particular customer.

6. The method of claim 1, further comprising:
generating a visualizing a domain-specific proficiency score based upon customer satisfaction score and a customer effort score.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
receiving a customer issue associated with a particular customer;
classifying the customer issue;
determining a solution to the customer issue;
identifying an optimum support issue resolution option;
implementing the optimum support issue resolution option; and,
measuring customer satisfaction regarding the support issue resolution.

8. The system of claim 7, wherein:
the measuring customer satisfaction comprises identifying customer dissatisfaction associated with customer issues of the particular customer.

9. The system of claim 8, wherein:
the optimum support issue resolution option comprises assigning a case manager to the customer issue and providing an automated response to the customer issue to resolve the customer issue.

10. The system of claim 9, wherein:
the classifying comprises generating a customer sentiment score, an issue complexity rating and a classification confidence rating; and,
the case manager is assigned to the customer support issue when the customer sentiment score regarding the support issue resolution is lower than a predetermined level.

11. The system of claim 7, wherein the instructions executable by the processor are further configured for:
using the customer satisfaction regarding the support issue resolution when identifying a new optimum support issue resolution option for the particular customer.

12. The system of claim 7, wherein the instructions executable by the processor are further configured for:
generating a visualizing a domain-specific proficiency score based upon customer satisfaction score and a customer effort score.

13. A non-transitory, computer-readable storage medium embodying computer program code, the computer program code comprising computer executable instructions configured for:
receiving a customer issue associated with a particular customer;
classifying the customer issue;
determining a solution to the customer issue;
identifying an optimum support issue resolution option;
implementing the optimum support issue resolution option; and,
measuring customer satisfaction regarding the support issue resolution.

14. The non-transitory, computer-readable storage medium of claim 13, wherein:
the measuring customer satisfaction comprises identifying customer dissatisfaction associated with customer issues of the particular customer.

15. The non-transitory, computer-readable storage medium of claim 14, wherein:
the optimum support issue resolution option comprises assigning a case manager to the customer issue and providing an automated response to the customer issue to resolve the customer issue.

16. The non-transitory, computer-readable storage medium of claim 15, wherein:
the classifying comprises generating a customer sentiment score, an issue complexity rating and a classification confidence rating; and,
the case manager is assigned to the customer support issue when the customer sentiment score regarding the support issue resolution is lower than a predetermined level.

17. The non-transitory, computer-readable storage medium of claim 13, wherein the computer executable instructions are further configured for:
using the customer satisfaction regarding the support issue resolution when identifying a new optimum support issue resolution option for the particular customer.

18. The non-transitory, computer-readable storage medium of claim 13, wherein the computer executable instructions are further configured for:
generating a visualizing a domain-specific proficiency score based upon customer satisfaction score and a customer effort score.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
